(19) United States
(12) Patent Application Publication
(10) Pub. No.: US 2005/0278433 A1
(43) Pub. Date: Dec. 15, 2005

(54) System and method for the transmission of data

(76) Inventors: Ronald M. Levi, Calabasas, CA (US); Shai Shprung, Calabasas, CA (US)

Correspondence Address: Anna M. Vradenburgh;Koppel, Jacobs, Patrick & Heybl, Suite 107, 555 St. Charles Drive, Thousand Oaks, CA, 91360, US

(21) Appl. No.: 11/150,723

(22) Filed: Jun. 9, 2005

Related U.S. Application Data
(60) Provisional application No. 60/578,884, filed on Jun. 10, 2004.

(51) Int. Cl. G06F 19/00

(52) U.S. Cl. 709/213

(57) ABSTRACT

Embodiments of the present invention are directed to a data transmission system for transmitting data to a user operating on a network. Embodiments of the data transmission system comprise a storage device coupled to the provider computer; a data input device for copying a source data set to the storage device; a user interface; and a media transmission system, the media transmission system being configured to retrieve and transmit data stored on the storage device.

### RELATED APPLICATIONS

This application is related to U.S. Patent Application, Ser. No. 60/501,966 entitled System, Method And Apparatus For Selecting And Exchanging Rental Items, filed on Sep. 11, 2003 and is incorporated herein by reference, and further claims the benefit from U.S. Application Ser. No. 60/578,884, entitled System and Method for The Transmission of Data, filed on Jun. 10, 2004.

### FIELD OF THE INVENTION

Embodiments of the invention are directed to a system, method and apparatus for providing users accessibility to an ancillary data set associated with a selected primary data set without interrupting the transmission of the primary data set.

### BACKGROUND OF THE INVENTION

Wide area networks, such as the Internet, have introduced a new medium for the display and transmission of data among users, and have increased the opportunity for users to easily share information traditionally stored on transportable storage mediums. In particular, data stored on transportable medium, such as video tapes and digital video discs (“DVDs”) often contains popular information, such as, current movies, that users desire to share.

To alleviate the need for lending the physical tape or disc, techniques have been developed to upload and store data, such as, movies or programs, from transportable tapes or digital media to a computer storage device that can be transmitted to network users for storage or real time viewing (streaming). Indeed, file sharing groups and services for transmitting stored information have become popular.

To make the data accessible to network users, the data must be separately copied from the transportable medium source. Traditionally, to copy prerecorded video data users simply inserted the prerecorded source data into a recorder and transferred the source data to the target medium by a simple copy command. This copy command captured all of the data on the source tape, including regulatory information, such as, FBI warnings and copyright notices that are typically stored on the medium prior to the storage of the movie. Unfortunately, in addition to the desired data and regulatory information, many prerecorded media began to include trailers or advertisements for other goods or services. Thus, with respect to video tapes, simply copying the entire tape captured other non-useful information contained on the tape and thus, required more medium for copying. As such, to eliminate the undesired information required a more careful monitoring of the copy process and thus, increased the amount of labor required by the user.

Although the transfer of data contained on a video tape can be accomplished by a simple copy command, DVDs, which have become a more desirable media due to the superiority of the quality of the original data and the subsequent preservation of data, present a different format. In particular, regulatory information and advertisements are physically segregated from the source data on the DVD, and thus, a copy may not include both the movie and the notices. The segregation of the source data and regulatory data into different files not only increases the amount of time required to copy the DVD, but further, affects the manner in which the user can view the data. Specifically, once the performance of DVD has commenced, the regulatory data, which is presented before the movie, cannot be re-viewed by a user without completely restarting the DVD, that is, the DVD cannot be rewound to view the regulatory data and subsequently fast forwarded to recommence play of the movie. Thus, in many instances, any information other than the source data is ignored in the copy process, or if copied, is not conveniently accessible to the user.

For services that offer streaming video data, it is desirable to make the regulatory information accessible or viewable by users. Indeed, intentional removal of such notices can be legally problematic. As discussed above, the inclusion of the regulatory information increases the cost of labor to copy the source data to the storage medium used in streaming the data to users at a later time. Further, the inclusion of the regulatory information increases the file storage space required to store the movie, and thus, increases storage costs.

With reference to FIG. 1, some current media players 10, such as Microsoft Media Player 9, comprise a first display window 12 and a second display window 14 wherein the primary data, such as, a movie, is displayed in the first display window 12 and the regulatory data, such as a copyright notice, is displayed within the second display window 14 of the player. The regulatory data is continuously streamed or scrolled across the second display window 14 during the playing or streaming of the primary, or desired, data. Although a user can read the data as it scrolls, the user cannot stop the scroll of the data or access it at any time. Rather, the user must wait for the data to scroll past to view the information. Thus, although the information is seemingly available, the user cannot readily access the information. Further, the scrolling of the data is only practical for very short messages, and thus, full warnings and notices are not made available. Thus, this is an insufficient solution if a notice or regulatory data must be fully made available to a user.

One possible solution to obtain a full display of regulatory data, such as, notices required pursuant to 18 U.S.C. Section 2257, is to copy the box cover of the original transportable source medium. A problem with this solution is that the amount of information contained on the box requires a tremendous amount of storage capacity. If this information is copied, due to the size of the stored data, the streaming of such data is prohibitively slow, and thus makes such streaming impractical for users. If the data were simply displayed in the media window, rather than streamed, the display would be difficult to read as the resolution for network content, in particular, internet content, is such that the font size to display data is generally no greater than 8 point font. If the font size were simply increased, only a limited number of words could be placed on a page, thereby requiring a multitude of pages to display the data. As such, in current systems it is impractical to make the data legible. Further, if such data were streamed, it would require a large amount of bandwidth and, as discussed above, the consumer could not repeatedly view the data.

A need in the industry exists for the ability to access ancillary data associated with selected primary data such that it is easily and repeatedly accessible to a user without the interruption of the streaming of the source data. A further need exists for the display of such associated data in a format that can be read by a user.

### SUMMARY OF THE DISCLOSURE

Embodiments of the present invention are directed to a data transmission system for transmitting data to a user, the data transmission system operating on a network comprising a provider computer and a user computer coupled for communication therebetween. Embodiments of the data transmission system comprise a storage device coupled to the provider computer; a data input device for copying a source data set to the storage device, the data input device being configured to encode and store the source data set in at least one display format; a user interface, the user interface being accessible to the user computer; and a media transmission system, the media transmission system being configured to retrieve and transmit data stored on the storage device, the media transmission system being accessible to the user computer via the user interface.

A feature of preferred embodiments is the locator coupled to a separate ancillary file. An advantage to this feature is that predefined information can be easily accessed by the user by activating the locator. A further advantage to this feature is that the storage space required for the ancillary file is relatively small and thus reduces storage requirements. A still further advantage is that the ancillary file can be independently updated without affecting the primary data file.

A further feature of preferred embodiments is that the reference locator is embedded in the source data via the second data set. An advantage to this feature is that the locator is always coupled to the primary data.

A further feature of preferred embodiments is that the ancillary file can be accessed independently from the primary data file. An advantage to this feature is that the primary data file can be streamed without interruption due to the accessing of the ancillary file.

A still further feature of preferred embodiments is that information pertaining to the underlying data received by a user can be updated independently from the underlying data. An advantage to this feature is that it allows the provider of the data to update associated information, thereby allowing the provider to remain compliant with legal requirements, or update relevant information for the user, such as, advertisements, or other information relevant to the underlying data such as copyright notices, or change in the ownership of the data.

Another feature of preferred embodiments is that the second data set can be dynamic. An advantage to this feature is that the accuracy of the second data set can be maintained, such that a user can access updated information associated with the second data set regardless of when the user received the primary set data.

### BRIEF DESCRIPTION OF THE DRAWINGS

FIG. 1 is a front view of a display window.

FIG. 2 is a schematic of a transmission data system on a network system in accordance with a preferred embodiment of the invention.

FIG. 3 is a schematic of a file format in accordance with a preferred embodiment of the invention.

FIG. 4 is an exemplary third data set in accordance with a preferred embodiment of the invention.

FIG. 5 is a schematic of a user interface in accordance with the preferred embodiment of FIG. 2.

FIG. 6 is a schematic of a wireless transmission from a data transmission system to a television.

The detailed description of embodiments of the invention will be made with reference to the accompanying drawings, wherein like numerals designate corresponding parts in the figures.

### DETAILED DESCRIPTION OF THE PREFERRED EMBODIMENTS

Embodiments of the present invention are directed to a system and method for the transmission of source data to users on a network, wherein the source data comprises a first set of data and a second set of data. In preferred embodiments, the first set of data is the primary, or principal source data, such as a movie or other program, and the second set of data is ancillary data which can be independent from or associated with or related to the principal source data. In preferred embodiments, the ancillary data includes, but is not limited to, legal and regulatory notices and warnings, such as FBI copyright warnings, information provided pursuant to 18 U.S.C. §2257, trademark notices, information appurtenant to the primary data set (such as title, actor, and the like) and any combination thereof. In preferred embodiments, the second set of data can include a plurality of members, wherein each member can identify different data or information. In some preferred embodiments, the use or distribution of the first data set is governed by restrictions or regulations. As discussed below, the second data set can be used to identify these restrictions or regulations, or can be used to provide information required to comply with the restrictions or regulations, or can be used to provide the location of such information.

The second set of data can also include a pointer or reference locator, such as, a URL to a third data set (discussed below), wherein the third data set can include any type of data. The use of pointers and reference locators minimizes the amount of storage required by the transmission data system required for the ancillary data while still providing access to the data. In some preferred embodiment, the second data set can also include an icon or other link coupled to an executable program.

Embodiments of the present invention are configured to stream the first set of data, that is, the principal source data, to a user while concurrently making the second set of data, that is, the ancillary data, available to the user without the need to terminate the streaming of the principal source data to view the ancillary data. The source data is stored in a single file including both the first set of data and the second set of data, which is transmitted to the user. In some preferred embodiments, the source data is formatted such that it is compatible with a Windows Media format.

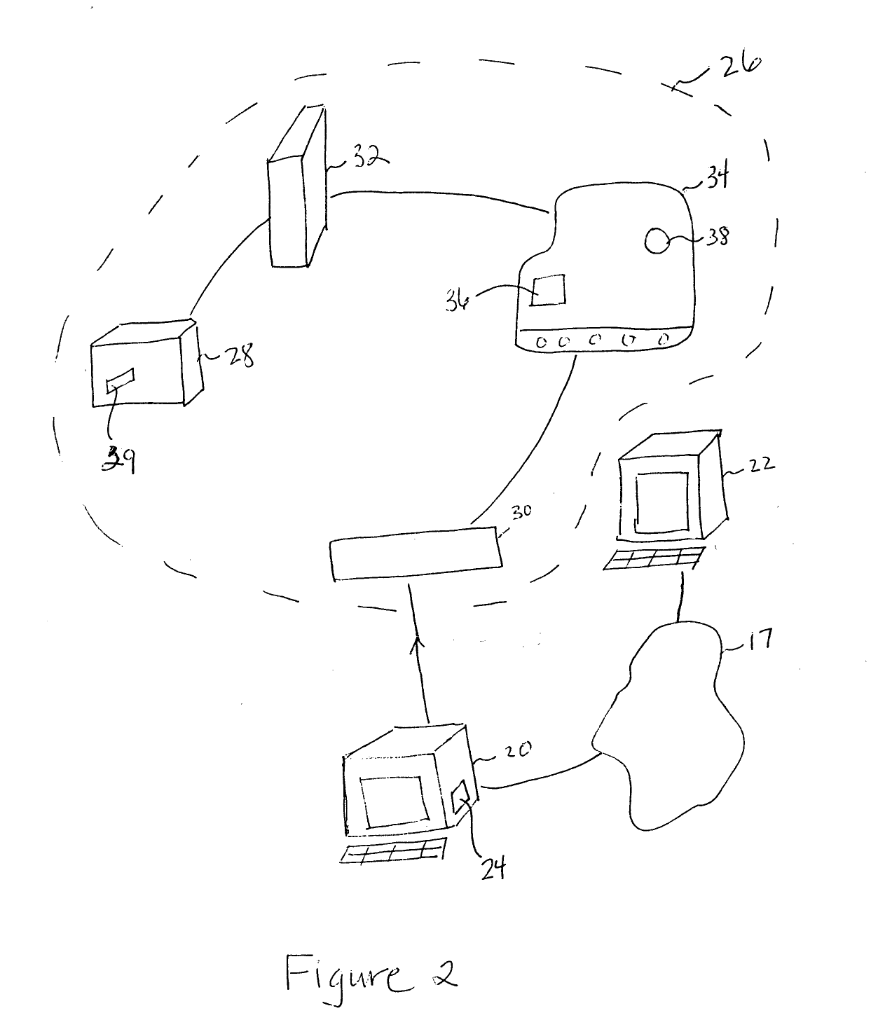

With reference to FIG. 2, embodiments of the present invention operate on a network, such as the Internet, having a provider computer 20 and a user computer 22, wherein the provider computer 20 and user computer 22 are coupled for communication via a communication link 17. The provider computer 20 comprises a processor 24 configured to operate a data transmission system 26. The processor is a central processing unit that is configured to receive input information from the user and appropriately direct the incoming input to the various components of the transmission system 26. In preferred embodiments, the data transmission system operates in conjunction with a web site controlled by browser functions as is commonly understood by those skilled in the art.

The data transmission system 26 comprises a data input device 28, a user interface 30, a storage member 32 and a media transmission system 34. In some preferred embodiments, the data transmission system does not include the data input device 28, but rather, couples to storage devices containing the source data.

The data input device 28 is a recording system that copies desired information, such as a movie, from one storage medium, or storage device, to a second storage device or storage medium, wherein the second storage device is accessible by the transmission system. The data input device 28 can be any suitable recording device, including but not limited to, a capture board on a computer and a digital video (dv) input. In preferred embodiment, the data input device 28 comprises an encoder 29 for encoding the data into predefined display formats. In some preferred embodiments, the data input device 28 copies or transfers information from any suitable storage mediums, including, but not limited to, a transportable medium such as a single movie disc, or a multi-storage medium (such as a disk drive) containing a plurality of data sets, such as movies, wherein the multi-storage medium is accessible by multiple users on a network.

The data input device 28 copies the source data in accordance with a user defined, or otherwise predefined format. In some preferred embodiments, the source data is initially copied and encoded multiple times via different encoding formats, and stored simultaneously in different encoded formats, wherein the different encoding formats correspond to different display formats. For example, in some preferred embodiments, the source data is stored in an encoded format for display on television and in an encoded format for display on a computer. Thus, if a user selects to display the source data on a television, the source data can properly transmit for the television format. In some preferred embodiments, the source data is also stored as originally copied, thereby allowing encoding for additional formats not originally designated by the user or system. In these instances, the data input device 28 is configured to retrieve the original copy and encode it in subsequently designated display formats.

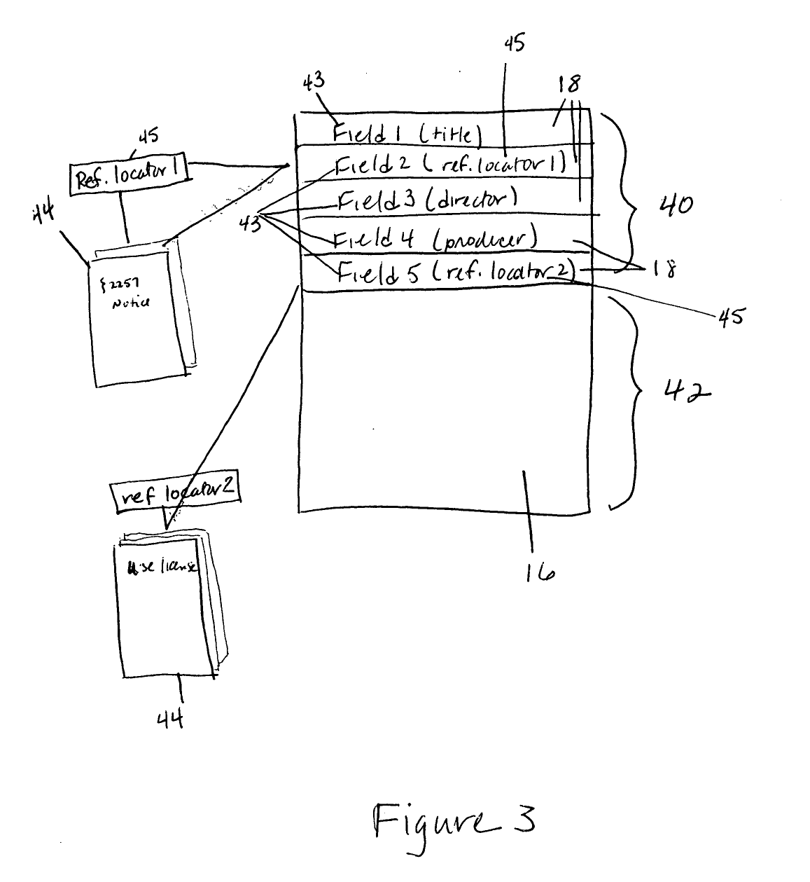

As discussed above, the data input device 28 copies the source data in accordance with a user defined, or default format(s). With reference to FIG. 3, in one preferred embodiment, the file format for the stored data comprises the first set of data 16 and the second set of data 18, wherein the first set of data is the primary data and the second set of data is the ancillary data. In preferred embodiments, the second set of data resides in a header section 40 and the first set of data resides in a target data section 42, wherein the header section 40 comprises a plurality of field variables or members 43. In preferred embodiments, the field variables 43 are predefined by default, although the predefined value can be reassigned by the user. For example, and with respect to a movie, the field variables 43 can be assigned title information, regulatory information (for example, copyright notices), and source data information (such as the name of the director, actors and rating of film).

As stated above, although the field variables 43 can have a default or predefined value, the field variables 43 can be reassigned by the user, and are not limited to static information. Indeed, in preferred embodiments, the field variable can be assigned a pointer or a reference locator, such as, a URL, or a file location. The reference locator 45 is associated with a third data set 44, including, but not limited to, an ASCII file, graphics, a web page(s), and an executable computer program. The location of the third data set is identified by the reference locator. Thus, the third data set can be stored locally, or at a remote storage location. In addition, a copy can be stored on the user's computer at the request to download or transmit the first data set. The third data set is independent of the source data, although it can be associated with, or related to, the source data. Further, due to the separate storage of the third data set, it can be changed or updated independently from the source data. In this regard, the field variable associated with the reference locator identifies data that can be dynamic in nature. For example, if the reference locator is a URL for a website, or a file location, the user is directed to a website or independent text file, respectively, that may be constantly changed or updated. In this regard, the user will receive the most recent information. For example, if the reference locator directs the user to an ASCII file containing notice information for the custodian of records under 18 USC §2257, if the name of the custodian of records changes, the file can be independently changed such that all users will receive the new information upon access to the locator, even if the source data was transmitted to the user and stored at an earlier time. In addition to being associated with the source data, the third data set can be a subset of the second data set, or can include other data that the provider desires to make accessible to the user. For example, the third data set can be an advertisement, or a listing of other movies produced by the producer of the source data.

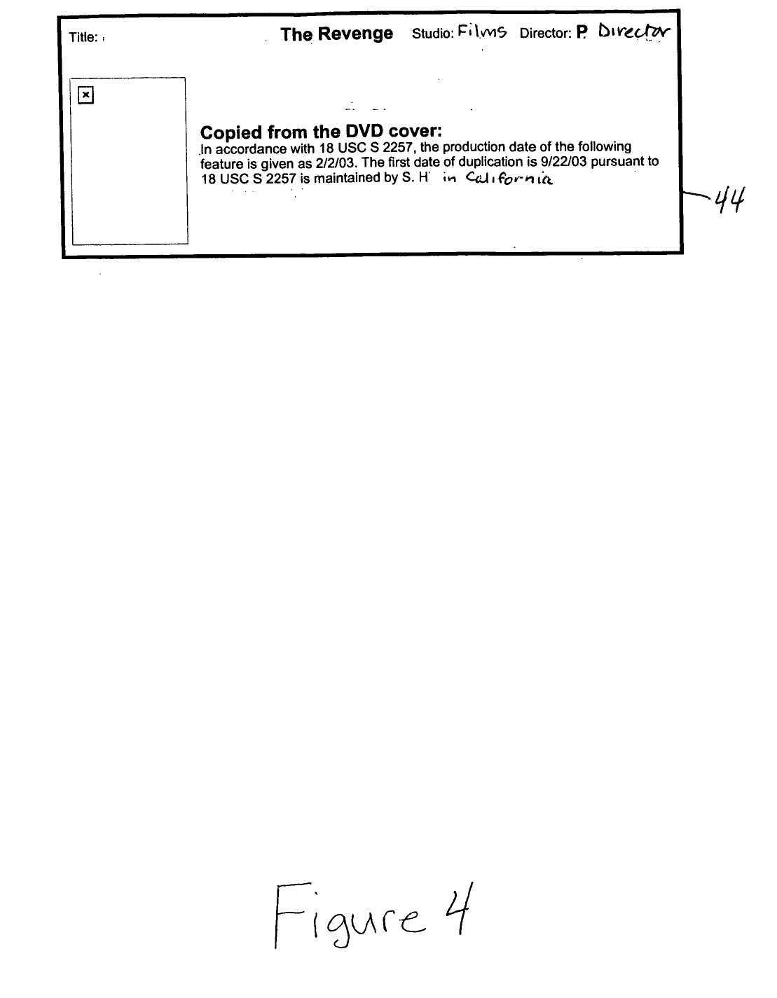

In some preferred embodiments, the data contained in the third data set is determined by the content contained in the first data set. For example, the terms of a use license or statutorily defined information, such as that required pursuant to 18 USC §2257, may be required to be made accessible to users. For example, with reference to FIG. 4, in preferred embodiments, the third data set 44 is stored as an ASCII file that contains information associated with the first data set, such as information required pursuant to 18 U.S.C. §2257. In some preferred embodiments, the reference locator(s) 45 is stored in the storage member as part of the second data set and is a hyperlink that directs the user to the location of the associated third data set(s) upon activation of the reference locator(s). As discussed above, the third data set can be stored in a remote storage location or in the local storage member.

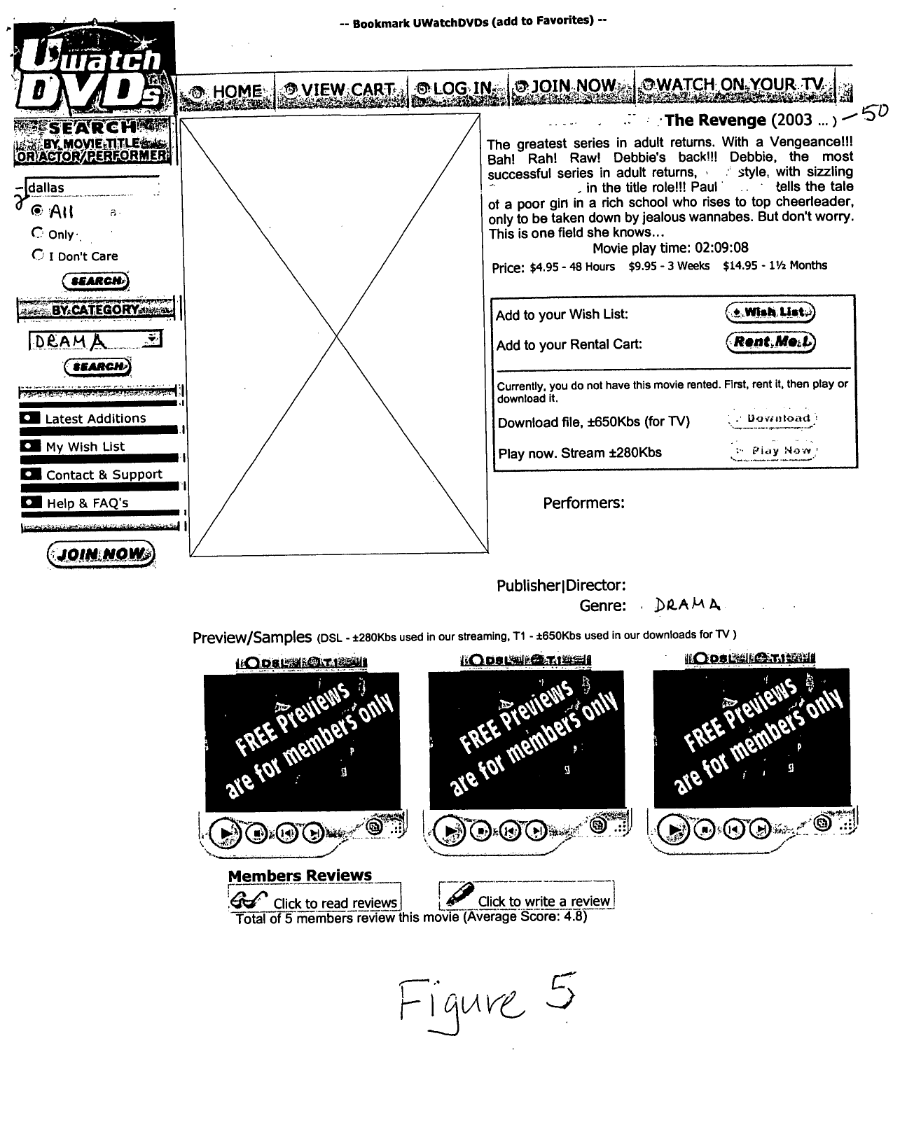

In preferred embodiments, the reference locator can be inserted or substituted into various locations of a user interface 30 (discussed below) that are accessible by the user. In preferred embodiments, the reference locator can be coupled to information related to selected data, such as the title. For example and with reference to FIG. 5, in one embodiment reference locators are embedded within the user interface 30 of the data transmission system. In this embodiment, the reference locator is associated with a title hyperlink 50, wherein clicking on the title hyperlink 50 opens the third data set (see FIG. 4) associated with the linked reference locator 44. Thus, in one example, the accessing of the reference locator, namely, the title hyperlink 50, directs the user to the notice requirements associated with the source data (see FIG. 4).

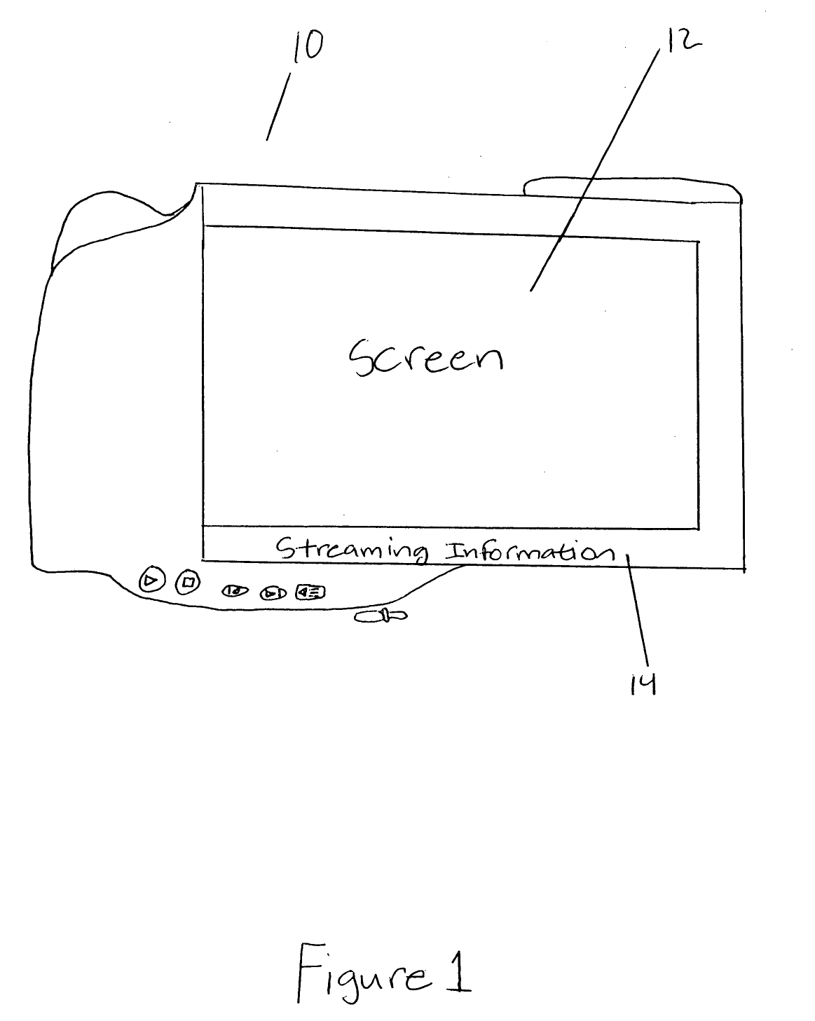

Additionally, the reference locator(s) can be inserted into other links contained in the browser, such as the properties link accessed via the “File” pull down menu contained in many current browsers. Further, in preferred embodiments and with reference again to FIG. 1, the second data set, or predefined information contained within the second data set, can be scrolled as part of the ancillary data within the second display window 14. If a reference locator is part of the second data set included in the display window 14, the reference locator will also scroll within the window. In each of these instances, upon activating the locator or accessing the locator by any suitable means, including, but not limited to, retyping the locator into a browser window, clicking on the locator link, or via automatic execution of an execution program, the third data set associated with the reference locator is opened and the user can view the file without interrupting the streaming of the first data set in the first display window 12. In preferred embodiments, the reference locator can be activated at any time, including during the transmission or play of the first data set to the user. In this regard, the ancillary data, or subset thereof, can be repeatedly viewed by users without interruption of the transmission. In some embodiments, if desired, a user can pause the transmission of the first data set while viewing the second data set, or any portion thereof.

The data transmission system 26 is accessible to the user computer via a user interface 30. In preferred embodiments, the user interface is a series of web pages which are accessible to the user via a web site identified by a uniform resource locator (URL) and can be further associated with a domain name, wherein the web site is controlled by a browser, such as Netscape or Windows. The user inputs information via input boxes or pull down menus. The user interface 30 allows the selection of data for viewing or transmission, and further accepts user input information, such as payment information, user identification and password. FIG. 5 is an example of a portion of a user interface in some preferred embodiments. Any means for obtaining and selecting the data for viewing or transmission is suitable, including, but not limited to, selection from a database, a peer to peer network, and selection of a link from a search result.

The storage member 32 is any suitable storage device, including an internal storage memory or external storage memory. The storage device contains information that has been copied from other storage medium, such as, video tapes and DVDs. Typically, the copied information includes the first set of data (the primary data), and the second set of data (the ancillary data), wherein the first and second data sets are related. Primary data include, but are not limited to, movies, programs, books, and other audio visual works. In general, the primary data comprise the contents of the movie or program. The ancillary data is any data appurtenant to, or associated with the first set of data, including, but not limited to, legal and regulatory notices and warnings, such as FBI copyright warnings, information provided pursuant to 18 U.S.C. §2257, trademark notices and any combination thereof. The storage of primary data and ancillary data creates a library of databases available for use by network users, wherein the primary data database is related to the ancillary database.

In addition to the source data, the storage device can further include user information, including identifying user information and payment information. In some preferred embodiments, a database for each set of data is created and stored in the storage member 32. The storage member 32 is coupled to the user interface 30 via the provider computer 20 and receives information therefrom. In some embodiments, the storage member 32 is also coupled to the data input device 28, wherein data is directly stored in the storage device.

The media transmission system 34 is configured to retrieve and transmit requested data that has been stored. In one preferred embodiment, the media transmission system 34 comprises a search engine 36 and a media player 38. The search engine is a processor that is configured to receive input data from the user interface 30. The search engine is coupled to the storage member 32 and searches the storage member to retrieve the source data, including the first set of data and the second set of data, identified by the user, for example, by the name of a movie. In other preferred embodiments, the media transmission system does not include a search engine.

The media player 38 is any device configured to transmit the selected data for viewing by the user. In one preferred embodiment, the media player 38 is a software program, such as Microsoft Media Player 9, that controls the transmission of the first and second set of data for viewing. In other preferred embodiments, the media player includes, but is not limited to, a television, a personal digital assistant (pda), POD, a telephone, a wireless device, or any other suitable device for transmitting and displaying data. In preferred embodiments, the media player 38 includes controls for controlling the playback of the data, including, play, pause, rewind and fast forward. (See, for example, FIG. 1).

The media transmission system 34 is coupled to the storage device. In preferred embodiments, the media player 38 comprises a screen for display of data comprising a first display window 12 and a second display window 14, wherein the second display window 14 (see FIG. 1) displays the ancillary data associated with the target data. As discussed above, in preferred embodiments, the reference locator can be included in the scrolling data in the second window display 14 such that the user can access the third data set associated with the transmitted data at any time. Overall, a library of data is created and stored the storage member 32 which is coupled to the transmission system, wherein the copied data is compressed and transmitted to the storage member accessible by the network.

In operation, a user, desirous of obtaining the data stored in the storage device, joins a service that provides access to the data. For convenience, the process will be described with reference to a user renting or accessing movies. Once a user has registered with the service, with reference to FIG. 5, the user can access the user interface 30 and input a search term in a search input box 52. The search term can be the title of a movie, or on any other relevant term, such as an actor's name or producer's name. Upon submission of the search request, the search engine reviews the storage member 32 and any other third party storage devices designated by the system. The search engine retrieves a listing of all relevant listings which are displayed to the user (not shown).

The user selects a title from the listing and can download the movie for later play or view the movie during transmission. During transmission to the user, the data is uncompressed and transmitted in accordance with a predefined format. The techniques for storing, compressing, uncompressing and transmitting such information is performed in accordance with techniques known to those skilled in the art, and is not discussed herein. In some preferred embodiments, a termination code is included within the downloaded data file, wherein the termination code sets a date whereby viewing of the file by the user is terminated.

If the user desires to view the ancillary data or a subset thereof, the user can link on the identifier of the movie 50, wherein the associated data file will open (see FIG. 4). Further, during the play of the movie, the regulatory data and reference locator(s) are repeatedly transmitted across the second display window 14. At any time during the transmission of the movie, the user can activate a reference locator and open the ancillary data file. This can be performed repeatedly without interrupting or restarting the movie. The user can play the movie as it would be played on a video recorder or DVD recorder playback machine, wherein the user can play, pause, rewind and fast forward the movie.

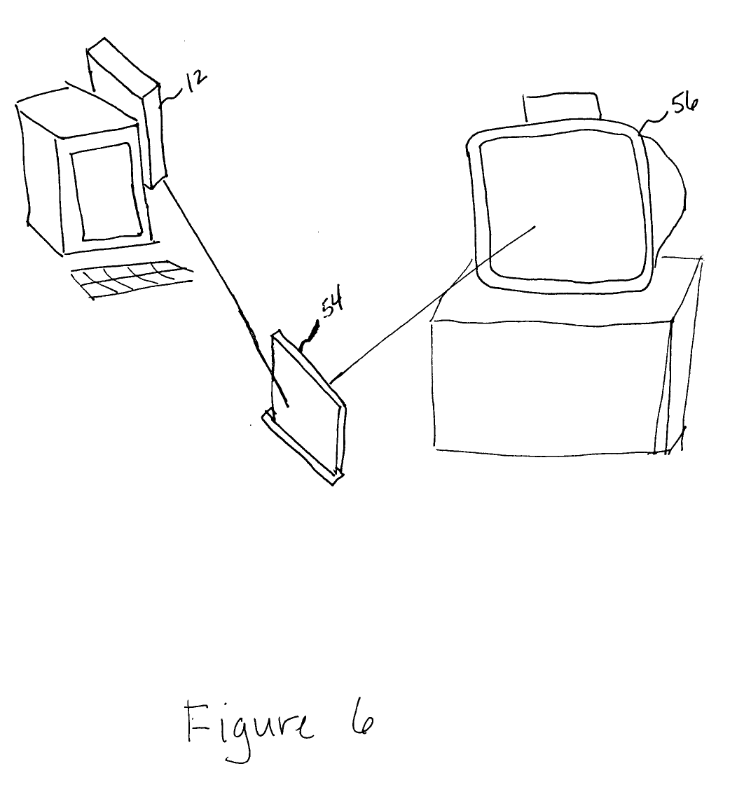

In preferred embodiments, the user can select the media player with which to view the movie, including the user computer 12, a television (see FIG. 6), an IPOD, a pda, a telephone, a wireless device or any other device configured to receive and display transmitted data. Indeed, as the original data is encoded for various media players, the playback will not require further reformatting of the data, thereby eliminating any delays in transmission to the user.

In one preferred embodiment, to utilize the television as the media player, the provider computer is coupled to the television. In some preferred embodiments, the provider computer is coupled to the television via a videocard with a TV-Out device, also known as Video-Out or S-Video-Out devices. Some examples of suitable video cards that support TV-Out include, but are not limited to, Matrox Parhelia Series, Matrox P & Millennium Series, Matrox G Series (such as G200, G400, G450, G500), Matrox QID, ATI Videocards, and n Videia cards (GeForce FX-Based Graphics card). Coupling of the computer to the television is well known and a description of the process will not be set forth herein. In some instances, if the video card includes standard compatible outputs, such as RCA compatible outputs, a wireless video/audio transmitter and receiver can be used to transmit video/audio from the provider computer to the television, regardless of the location of the television. For example, the television may reside in a different room than the provider computer.

In other preferred embodiments, a VGA to NTSC Scan converter can be used. In these embodiments, the converters have a VGA pass through such that the signal can be viewed from both a display monitor (for example, a PC monitor) and on a television. Suitable products include, but are not limited to, AITech PC-to-TV by AITech International Corporation, Focus Enhancements by focusinfo.com, and Keyzone TVview.

In still another embodiment, a wireless network can be used to transmit the data from the computer to the television. For instance and with reference to FIG. 6, in one preferred embodiment, a receiver/transmitter 54 is wirelessly coupled to the provider computer 12 and a television set 56, wherein the data is transmitted from the provider computer 12 to the television set 56 via the receiver/transmitter 54. Some suitable products include, but are not limited to, HP Ditigal media receiver, Pinnacle Showcenter, Wireless VGA to TV converter, XBOX, and Intel NMP-4000.

Finally, in some preferred embodiments, the user can download the movie to the user computer for later playback. In these instances the user selects the media player at a later time or after the download of the data is complete.

While the invention has been particularly shown and described with reference to preferred embodiments thereof, the embodiments are not intended to be limiting. Indeed, the foregoing is intended to cover all modifications and alternative constructions falling within the spirit and scope of the invention.

1. A data transmission system for transmitting data to a user, the data transmission system operating on a network comprising a provider computer and a user computer coupled for communication therebetween, comprising:
a storage device coupled to the provider computer;
a data input device for copying a source data set to the storage device, the data input device comprising an encoder, the encoder being configured to encode and store the source data set in multiple display formats;
a user interface, the user interface being accessible to the user computer; and
a media transmission system, the media transmission system being configured to retrieve and transmit data stored on the storage device, the media transmission system being accessible to the user computer via the user interface.

2. A data transmission system as claimed in claim 1, wherein the source data set comprises a first set of data and a second set of data, the first set of data being a primary data set and the second set of data being an ancillary data set, wherein the primary data set is related to the ancillary data set.

3. A data transmission system as claimed in claim 1, wherein the second set of data comprises a plurality of members, and further comprising a third data set, wherein at least one member of the second data set is a reference locator, the reference locator being coupled to the third data set.

4. A data transmission system as claimed in claim 1, wherein the media transmission system further comprises a search engine and a media player, the search engine being configured to retrieve the copied source data from the storage device.

5. A data transmission system as claimed in claim 1, wherein the search engine transmits the copied source data to the encoder, wherein the encoder encodes the source data into a second display format and stores the second display format in the storage medium.

6. A data transmission system as claimed in claim 1, wherein the source data set comprises a first set of data and a second set of data, the source data being stored in a format comprising a target data section and a header section, wherein the first set of data is stored in the target data section and the second set of data is stored in a header section.

7. A data transmission system as claimed in claim 6, the header section comprising:
a plurality of field variables, each field variable being associated with a defined information set.

8. A data transmission system as claimed in claim 7, wherein at least one of the field variables is assigned a reference locator, wherein the reference locator is associated with a third data set, the third data set being independent of the source data set.

9. A data transmission system as claimed in claim 8, wherein the third data set is dynamic in nature.

10. A data transmission system as claimed in claim 8, wherein the third data set is selected from the group consisting of an ASCII file, a graphic, an advertisement, a regulatory notice, a warning notice, a web page and an executable program.

11. A data transmission system as claimed in claim 8, wherein the third data set is modifiable independently from the source data set.

12. A data transmission system as claimed in claim 1, wherein the data transmission system is accessible to the user computer via a web site controlled by browser functions.

13. A data transmission system as claimed in claim 7, wherein the values of the field variables are selected from the group consisting of regulatory information, source data information, and a reference locator.

14. A data transmission system as claimed in claim 6, wherein the media transmission system comprises a media player and a search engine, the media player further comprising a first display window and a second display window, the first display window being configured to display the target section and the second display window being configured to display the header section, the display of the target section being substantially concurrent with the display of the header section.

15. A data transmission system as claimed in claim 6, the header section comprising a plurality of field variables, wherein at least one field variable is a reference locator, the reference locator being associated with a third data set, wherein the third data set is accessible to the user via the second display window without interrupting the display of the target section.

16. A data transmission system as claimed in claim 1 , wherein the user computer selects the format display for the transmission of source data, the media player retrieving the selected format display for the source data and transmitting the source data in the selected format display.

17. A data transmission system as claimed in claim 3, wherein the third data set is dynamic in nature.

18. A transmission system as claimed in claim 3 wherein the third data set is selected from the group consisting of an ASCII file, a graphic, an advertisement, a regulatory notice, a warning notice, a web page and an executable program.

19. A data transmission system as claimed in claim 3, wherein the third data set is modifiable independently from the source data set.

20. A method for transmitting data to a user via a data transmission system comprising a storage medium; and a media transmission system, the media transmission system comprising a media player, the data transmission system operating on a network comprising a provider computer and a user computer coupled for communication therebetween, comprising:
copying a source data set to the storage medium;
encoding the source data set in at least one display format;
storing the source data set in the at least one display format for transmitting the data to the user to a display device configured to receive the display format;
selecting the source data and the display format; and
retrieving and transmitting the selected stored display format for the source data.

21. A method for transmitting data to a user computer via a data transmission system comprising a storage medium; and a media transmission system, the media transmission system comprising a media player, the data transmission system operating on a network comprising a provider computer and a user computer coupled for communication therebetween, comprising:
copying a source data set to the storage medium, the source data comprising a first data set and a second data set, wherein the second data set comprises a plurality of members;
encoding the source data set in at least one display format;
assigning a reference locator to at least one member of the second data set, the reference locator being associated with a third data, the third data set being stored independently from the first and second data sets;
retrieving the first and second data sets for display via the media player;
retrieving the third data set by the reference locator for display on the user computer; and
displaying the third data set without cessation of the display first data set.

22. A method as claimed in claim 21, further comprising modifying the third data set without modifying the first or second data set.

23. A method as claimed in claim 21, further comprising modifying the third data set in accordance with restrictions identified with the first data set.

24. A method as claimed in claim 22, further comprising retrieving the modified third data set; and displaying the modified third data set without cessation of the first data set.
